(19) United States
(12) Patent Application Publication
(10) Pub. No.: US 2026/0133892 A1
(43) Pub. Date: May 14, 2026

(54) OPEN TELEMETRY RUNTIME PROFILER

(71) Applicant: Cisco Technology, Inc., San Jose, CA (US)

(72) Inventor: Walter Theodore HULICK, Jr., Pearland, TX (US)

(21) Appl. No.: 19/191,257

(22) Filed: Apr. 28, 2025

Related U.S. Application Data
(60) Provisional application No. 63/718,391, filed on Nov. 8, 2024.

(51) Int. Cl. G06F 11/362

(52) U.S. Cl. CPC G06F 11/3636

(57) ABSTRACT

According to one or more embodiments of the disclosure, an Open Telemetry runtime profiler is provided. In one embodiment, an illustrative method herein comprises: capturing, by a profiler process for inclusion in a set of observations, runtime metrics of a telemetry agent process on an associated host application; capturing, by the profiler process for inclusion in the set of observations, span information in real-time from the telemetry agent process; intercepting, by the profiler process for inclusion in the set of observations, exceptions caused by or within instrumentation code of the telemetry agent process; and providing, by the profiler process, an interface for sharing the set of observations associated with the telemetry agent process.

### RELATED APPLICATION

This application claims priority to U.S. Provisional Application No. 63/718,391, filed Nov. 8, 2024, entitled OPEN TELEMETRY RUNTIME PROFILER, by Walter Theodore Hulick, Jr., the contents of which are incorporated herein by reference.

### TECHNICAL FIELD

The present disclosure relates generally to computer networks, and, more particularly, to an Open Telemetry runtime profiler.

### BACKGROUND

Open Telemetry (OTEL) is fast becoming the standardized platform for Full Stack Observability. Currently, the Open Telemetry community offers an application programming interface (API)/software development kit (SDK) combination to instrument an application based on language type and/or a full Open Telemetry Agent which is capable of “Auto Instrumenting” various framework points to implement the OTEL signals (e.g., metrics, events, logs, traces, or “MELT” data).

Unfortunately, the actual Troubleshooting and Monitoring of the OTEL signals and pipeline is poor at best. There are numerous issues in the setup and there are many unknowns about what the impact of the sampling, etc. has on the application itself. Tuning is extremely difficult even for subject matter experts of Open Telemetry.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example observability intelligence platform;

FIG. 4 illustrates an example of runtime vital signs;

FIG. 5 illustrates an example of OTEL Span Tracking;

FIG. 6 illustrates an example of OTEL Agent Status;

FIG. 7 illustrates an example of an Agent Instrumentation Class List;

FIG. 8 illustrates an example of an Exception Summary caused by the Agent;

FIG. 9 illustrates an example of Exception Instances caused by the Agent;

FIG. 10 illustrates an example of OSS Agent Class Exploration;

FIG. 11 illustrates an example procedure for an Open Telemetry runtime profiler; and

FIG. 12 illustrates another example procedure for an Open Telemetry runtime profiler.

### DESCRIPTION OF EXAMPLE EMBODIMENTS

### Overview

According to one or more embodiments of the disclosure, an Open Telemetry runtime profiler is provided. In particular, the techniques herein provide a highly specialized profiler which is “tailor made” for Open Telemetry signaling (MELT), propagation, and components (exporters), which can be used to enhance and speed OTEL deployments for applications.

In particular, in one embodiment, an illustrative method herein comprises: capturing, by a profiler process for inclusion in a set of observations, runtime metrics of a telemetry agent process on an associated host application; capturing, by the profiler process for inclusion in the set of observations, span information in real-time from the telemetry agent process; intercepting, by the profiler process for inclusion in the set of observations, exceptions caused by or within instrumentation code of the telemetry agent process; and providing, by the profiler process, an interface for sharing the set of observations associated with the telemetry agent process.

In one embodiment, the method further comprises: discovering, by the profiler process for inclusion in the set of observations, configuration parameters of the telemetry agent process.

In another embodiment, the method further comprises: identifying, by the profiler process for inclusion in the set of observations, instrumentation classes active within the telemetry agent process.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

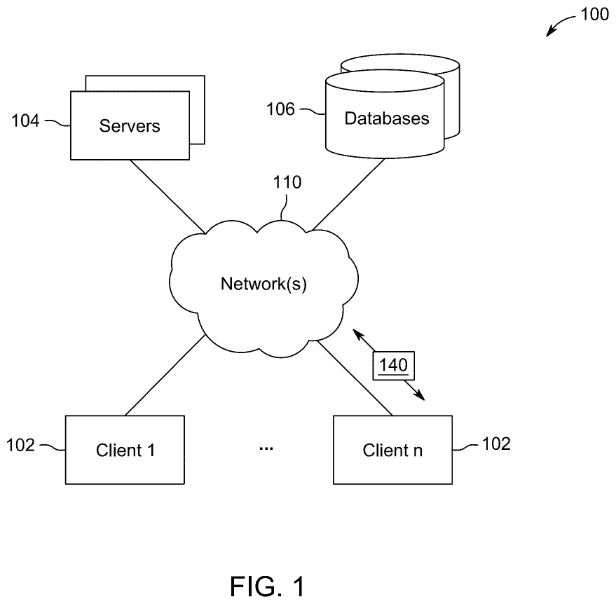

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to router a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

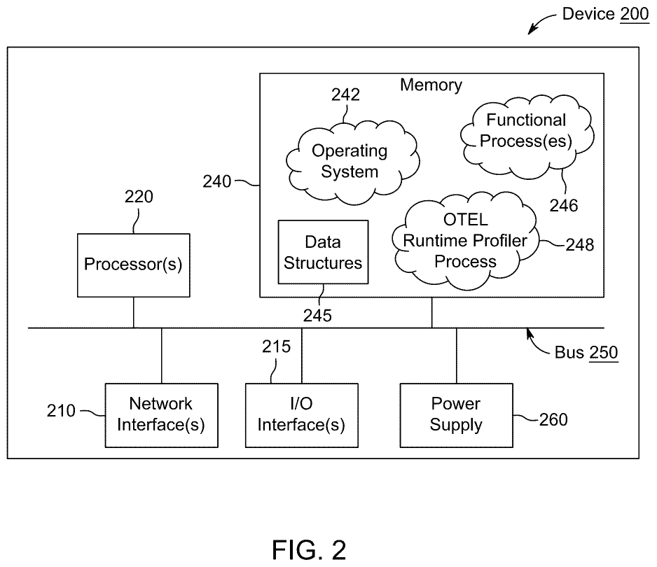

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, an “OTEL runtime profiler” process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### Observability Intelligence Platform

As noted above, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user's data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer's own internal IT network (e.g., the customer's enterprise IT network), a user's client device, and/or intermediate network providers between the user's client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicate the troubleshooting efforts.

Certain aspects of one or more implementations herein may thus be based on (or otherwise relate to or utilize) an observability intelligence platform for network and/or application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

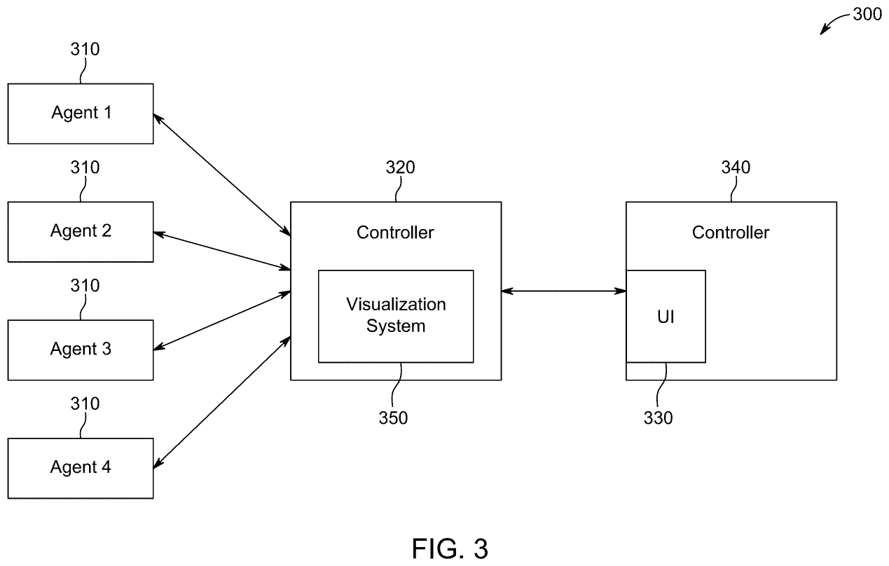

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users'(e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable implementation of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents (agents 310) and one or more servers/controllers (e.g., controller 320). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a browser-based user interface (UI) (interface 330) that is the primary interface for monitoring, analyzing, and troubleshooting the monitored environment. Specifically, the controller 320 can receive data from agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 330. The interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, an instance of controller 320 may be hosted remotely by a provider of the observability intelligence platform 300. In an illustrative on-premises (On-Prem) implementation, a controller instance may be installed locally and self-administered.

The controllers 320 receive data from different agents (e.g., Agents 1-4) deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain implementations, in the application intelligence model, a business transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

A business transaction, in particular, is a representation of the particular service provided by the monitored environment that provides a view on performance data in the context of the various tiers that participate in processing a particular request. That is, a business transaction, which may be identified by a unique business transaction identification (ID), represents the end-to-end processing path used to fulfill a service request in the monitored environment (e.g., adding items to a shopping cart, storing information in a database, purchasing an item online, etc.). Thus, a business transaction is a type of user-initiated action in the monitored environment defined by an entry point and a processing path across application servers, databases, and potentially many other infrastructure components. Each instance of a business transaction is an execution of that transaction in response to a particular user request (e.g., a socket call, illustratively associated with the TCP layer). A business transaction can be created by detecting incoming requests at an entry point and tracking the activity associated with request at the originating tier and across distributed components in the application environment (e.g., associating the business transaction with a 4-tuple of a source IP address, source port, destination IP address, and destination port). A flow map can be generated for a business transaction that shows the touch points for the business transaction in the application environment. In one implementation, a specific tag may be added to packets by application specific agents for identifying business transactions (e.g., a custom header field attached to a hypertext transfer protocol (HTTP) payload by an application agent, or by a network agent when an application makes a remote socket call), such that packets can be examined by network agents to identify the business transaction identifier (ID) (e.g., a Globally Unique Identifier (GUID) or Universally Unique Identifier (UUID)). Performance monitoring can be oriented by business transaction to focus on the performance of the services in the application environment from the perspective of end users. Performance monitoring based on business transactions can provide information on whether a service is available (e.g., users can log in, check out, or view their data), response times for users, and the cause of problems when the problems occur.

In accordance with certain implementations, the observability intelligence platform may use both self-learned baselines and configurable thresholds to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or business transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the eXtensible Markup Language (XML) format). Also, the REST API can be used to query and manipulate the overall observability environment.

Furthermore, for reference, the following discussion is a brief primer on OpenTelemetry:
An “OpenTelemetry Trace” is defined as one or more OpenTelemetry Spans with all Spans sharing a common trace ID.
An “OpenTelemetry Span” is reported from a monitored application by an OpenTelemetry SDK or auto-instrumentation agent and includes:
   A pointer to the “parent” span, the span that captures what happened immediately before this one;
   A set of attributes: Key/Value pairs with information about the running program;
   A status: to indicate whether the application hit an error while processing this part of the request;
   A span kind: helps describe what action this span captures (call entering/leaving a service, internal to the service, etc.);
   A set of resource attributes: Key/Value pairs with information about where the span came from;
   A name to summarize the operation the span represents; and
   A start and end time.

An OpenTelemetry system thus creates and/or ingests batches of spans from various sources (agents and collectors) into a backend system such as that described above. Notably, spans may be grouped by trace IDs into trace messages, and the trace messages may be processed, starting at the root, and following all parent-child links.

Each span in the traversal is evaluated as a potential starting point for a business transaction. (Note that business transactions can be nested.) In particular, evaluation criteria this can be based off of may be as follows:
Name;
The position of the span in the trace;
Span kind;
Resource attributes;
Span attributes;
Etc.
   Furthermore, the rules that define conditions on these criteria can be defined by:
The system (“out of the box”/automatic rules);
Machine learning algorithms evaluating the ingested data;
A user (custom rules);
And so on.

Once any criteria is met, a Business Transaction (BT) Entity gets created. Metrics are then reported for the BT based on the status, start, and end time of the span that discovered it. All subsequent traversal of this trace will then report data in the “context” of this BT.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

### Open Telemetry Runtime Profiler

As noted above, Open Telemetry (OTEL) offers an application programming interface (API)/software development kit (SDK) combination to instrument an application based on language type and/or a full Open Telemetry Agent which is capable of “Auto Instrumenting” various framework points to implement the OTEL signals (e.g., metrics, events, logs, traces, or “MELT” data). As also noted above, the actual Troubleshooting and Monitoring of the OTEL signals and pipeline is poor at best.

The techniques herein, therefore, provide an Open Telemetry runtime profiler, which is a highly specialized profiler that is “tailor made” for the Open Telemetry signaling (MELT), propagation, and components (exporters), which can be used to enhance and speed OTEL deployments with Applications.

As a reminder, Open Telemetry (or “OTEL”) generally refers to a collection of tools, application programming interfaces (APIs), and/or software development kits (SDKs). OTEL may be used to instrument, generate, collect, and/or export telemetry data (e.g., metrics, logs, and traces) that assist in analyzing the performance and behavior of a software system, as well as applications that are executed by the software system.

Notably, as will be understood by those skilled the art, an OTEL “span” is a data structure which represents a unit of work or an operation (e.g., within a transaction). Spans are the building blocks of traces, which are essential to understanding the full “path” a request takes in an application. Each Span is an observability-based data structure that encapsulates a number of states, such as an operation name, start and end timestamps, and a number of attributes (key-value pairs), among other fields (e.g., events, link, and so on).

In particular, as will be appreciated, a trace is generally a collection of parent/child spans, which are created during a transaction process. Each Span defines a “transition” in the trace (e.g., a web service call, web service entry, thread transition, etc.) process. Each span carries information about the span in “attributes,” as illustrated in the following pseudocode:
//get Current Span
Span span=Span.current( );
//Add custom attributes to Span
Span.setattribute(“schoolname”, Schoolname);

These attributes are eventually transmitted via a collector/exporter to a backend (e.g., backend receivers) via a wire protocol (e.g., via the Open Telemetry protocol (OTLP)—https://opentelemetry.io/docs/specs/otel/protocol/) and processed at the backend. That is, an Open Telemetry trace is made up as a series of spans—parent/child and they represent a flow and unit of work—each of which is eventually (if sampled) sent to a “collector” which exports them to a receiver to be recorded and eventually analyzed and to then appear in a dashboard to visualize the trace.

Notably, almost every IT organization in the world is targeting OTEL as their future platform for full-stack observability (FSO). Most have little knowledge of exactly what it is, and have no “in-house” expertise of how to deploy, optimize, monitor, and leverage its capabilities. That is, the tooling simply doesn't exist yet. Today, there are numerous companies that are looking at using “variations” of the OTEL Community Agent—known as the “OSS Agent”—and there are some variations of that Agent bundled with extensions.

For managing Open Telemetry, most of the Open Telemetry API/SDK usage today is via OSS Agents from the OTEL community, where the most widely used is the Java version. This Agent has logging capabilities, but visibility is very poor. It is possible to spend days troubleshooting an issue that could be mitigated in minutes if there were tools available that had the technical expertise to “tap” into this runtime and monitor it in real time.

In particular, standard tools that exist are subpar. There are Java Profilers from various vendors that exist—however they report on the entire runtime. They have no concept of instrumentation, OTEL signals, OSS community agents, receivers, exporters or other technical components that are vital to ensuring that the Open Telemetry instrumentation and export of MELT signaling is working correctly, while not overwhelming the runtime application. Current profilers will give some indications that things are not optimal and they will highlight where heap and CPU is accumulating-but again—that requires admins to manually filter through this information and correlate it to a Trace/Span being measured, still a manual process.

Operationally, the Open Telemetry runtime profiler herein is, essentially, an “Agent inside an Agent” or “Observability inside Observability”. That is, the OTEL runtime profiler is a “real-time portal” into the health/vital signs of the OSS Community Agent.

The “portal” itself is a lightweight web interface launched independent of the application or the OSS Agent. That interface receives commands and returns responses that show the various health metrics and current structures in the OSS Agent. However, the web interface can be substituted with other forms of communication - including Open Telemetry opAMP commands.

According to the techniques herein, the OTEL runtime profiler provides such things as:
Runtime Vital Signs;
OTEL status and configuration;
A “snapshot capture” of current Spans - and which class/method is creating the span;
A “snapshot capture” of exceptions (e.g., all exceptions) thrown/caused by the OSS Agent;
A “summary” of exceptions (e.g., all exceptions) thrown/caused by the OSS Agent;
A discovered list of the OSS Agent Instrumentation classes (e.g., all classes);
OSS Agent Class Exploration;
OSS Agent Thread CPU and activity;
And so on.

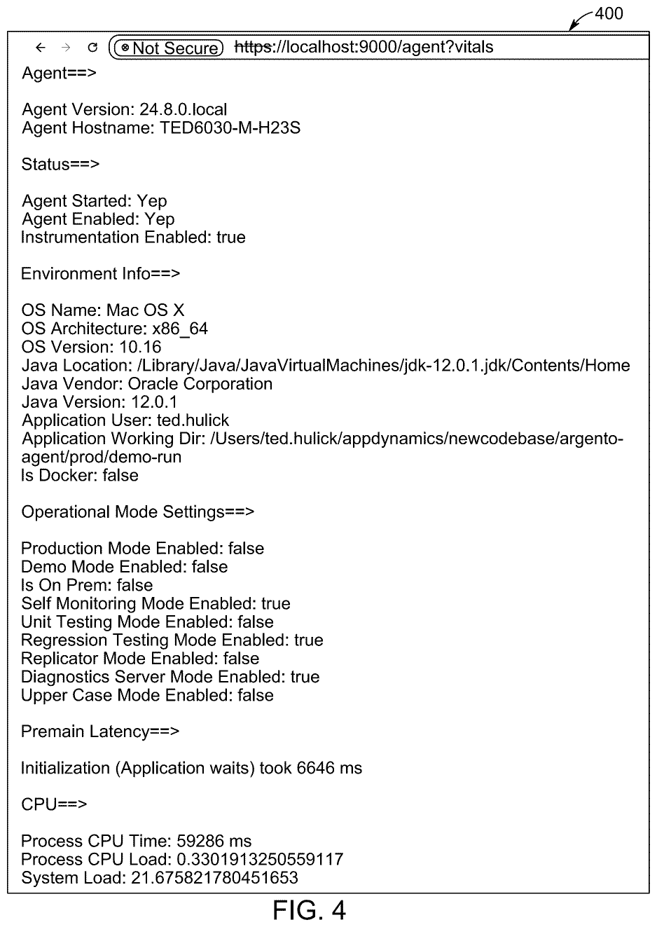

FIGS. 4-10 illustrate an example command and response exchange from an implementation according to the embodiments herein.

FIG. 4 illustrates an example of runtime vital signs 400, which provides a real-time snapshot of the OSS Agent's operational status and environment configuration. This includes agent metadata such as version, hostname, and instrumentation status, as well as detailed environmental information including the operating system, architecture, Java version, and working directory. In addition, operational mode flags are displayed, indicating enabled or disabled features such as self-monitoring, regression testing, and diagnostics. Performance metrics such as initialization latency, process CPU time, and system load averages are also captured, providing key insights into agent startup behavior and runtime resource utilization. These vitals may be collected out-of-band from the application logic, enabling accurate diagnostics of the OTEL agent without interfering with its normal telemetry flow.

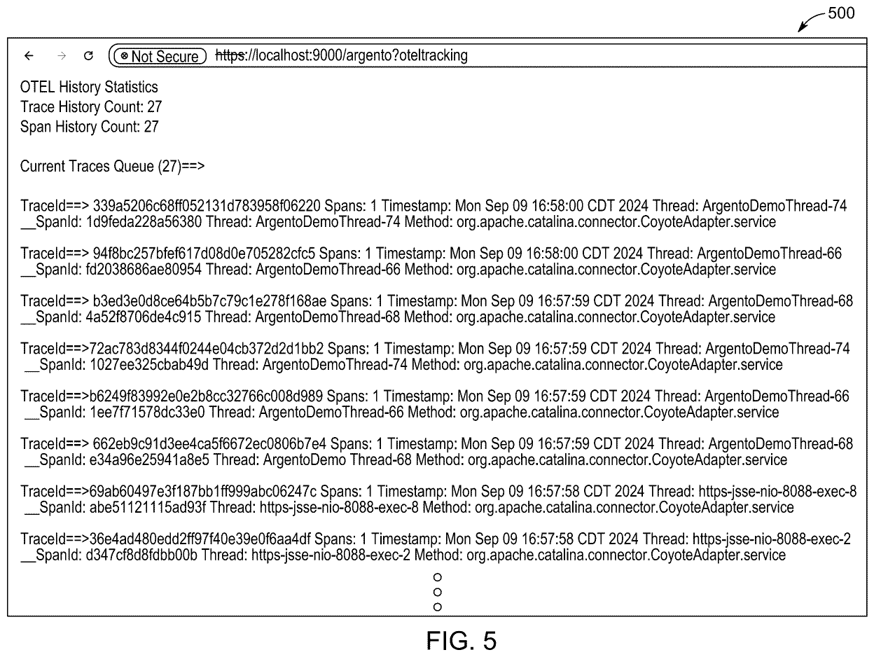

FIG. 5 illustrates an example of OTEL Span Tracking 500, which provides a snapshot of the current Spans Created (the last n Spans) and is frequently (e.g., constantly) updated. That is, the snapshot shows currently active or recently completed spans within the Open Telemetry pipeline. Each entry in the span queue includes a unique trace ID and span ID, along with the precise timestamp of span creation. Additional runtime context includes the executing thread name and the specific method or class where the span was generated. In the illustrated example (not meant to be limiting to the present disclosure), all spans originate from servlet-based HTTP activity, primarily through org.apache.catalina.connector.CoyoteAdapter.service. The profiler collects and refreshes this span history dynamically, allowing system administrators or developers to view the chronological sequence and origin of telemetry data as it flows through the instrumented application. This provides an immediate and accurate view into OTEL signal propagation without requiring manual correlation or backend dependency.

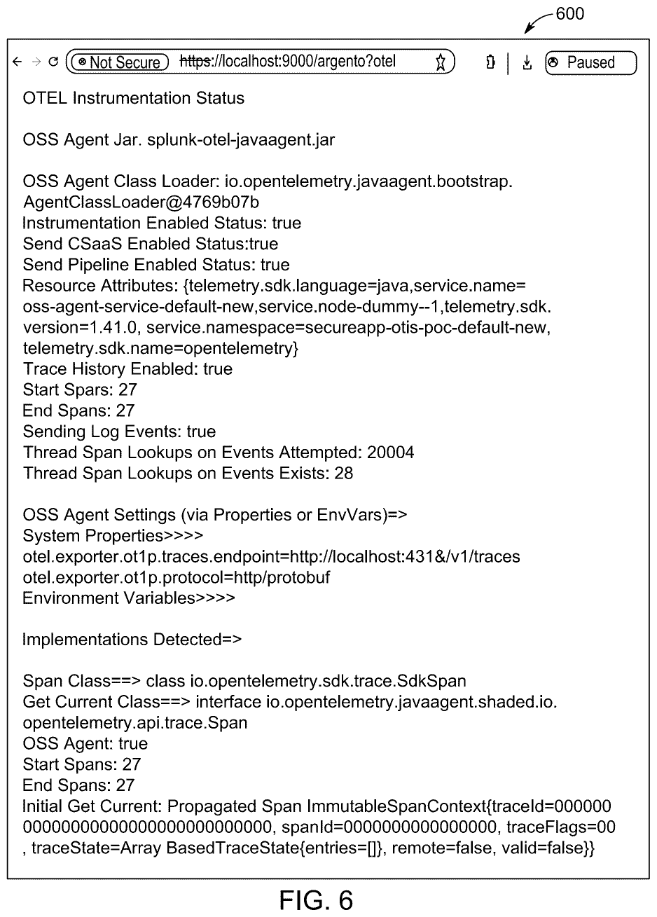

FIG. 6 illustrates an example of OTEL Agent Status 600, detailing the current OTEL Configurations and API/SDK implementations discovered (e.g., the current configuration, operational flags, and implementation specifics of the Open Telemetry agent). This includes identification of the OSS agent JAR, bootstrap classloader, and agent status, along with trace-related configurations such as span start/end counts, thread span lookup metrics, and export attempts. Active signal transmission flags for traces, metrics, and logs are shown, along with the full list of resource attributes (e.g., service name, namespace, version, and language, etc.) automatically captured and tagged by the agent. Exporter configurations are also identified, including endpoint URLs for trace data (http://localhost:4318/v1/traces) and the OTLP protocol (http/protobuf). Implementation classes for span management and agent interfaces are listed, confirming discovery of the SDK trace classes and providing runtime visibility into the exact span context currently active. This comprehensive status snapshot thus enables validation of agent functionality and system integration health.

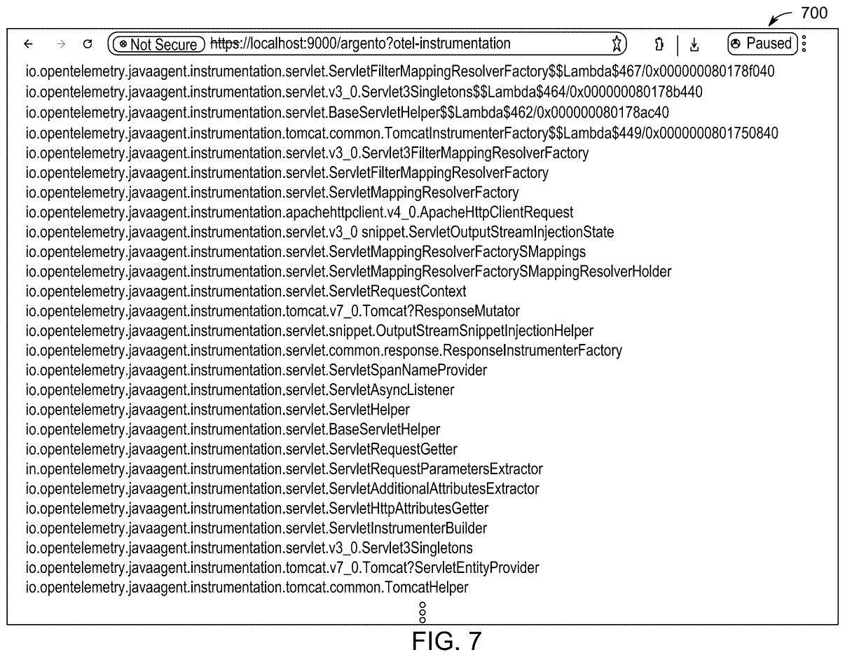

FIG. 7 illustrates an example of an Agent Instrumentation Class List 700, which displays the set of OpenTelemetry instrumentation classes actively detected by the runtime profiler. These classes, automatically discovered through OSS Agent Instrumentation (e.g., classpath scanning or runtime reflection), include servlet filters, listeners, context resolvers, attribute extractors, and other components from popular frameworks such as Tomcat, Apache HTTP, and standard Java EE servlets. Each class corresponds to a specific instrumentation hook enabled by the OSS Agent, revealing how telemetry signals (e.g., spans, metrics, logs) are injected into the monitored application. Some entries reflect lambda-based or dynamically generated instrumentation methods, further highlighting the runtime adaptability of the profiler. This view allows users to verify whether expected instrumentation modules are present and active, and whether additional modules may need to be enabled or optimized for comprehensive observability.

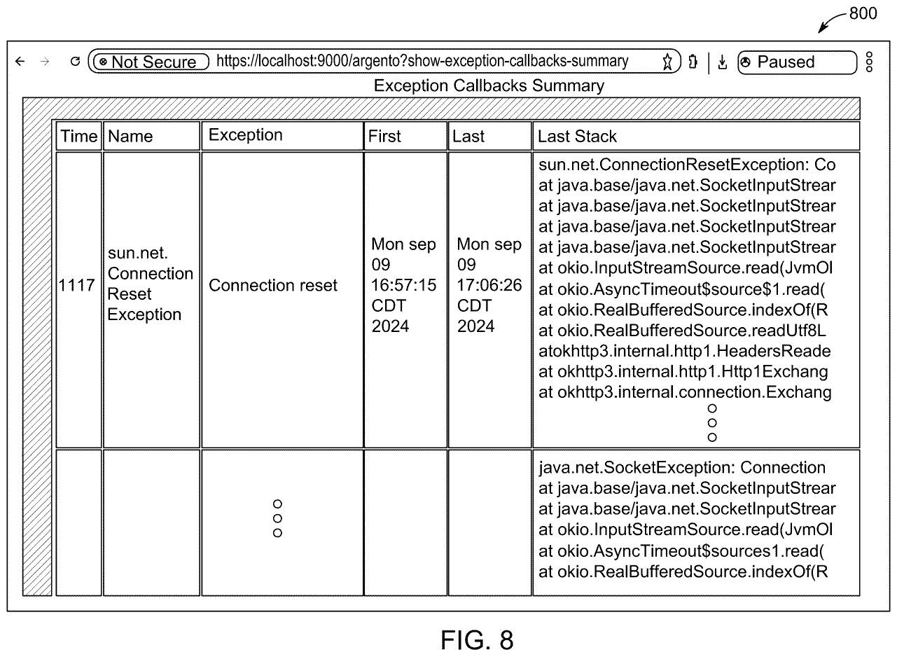

FIG. 8 illustrates an example of an Exception Summary 800 caused by the Agent. This is an exception summary report for all Exceptions involving the OSS Agent (as a cause), aggregating and categorizing runtime exceptions intercepted during OpenTelemetry instrumentation activity. The summary includes the exception type, such as sun.net.ConnectionResetException, alongside human-readable descriptions (e.g., “Connection reset”) and the total number of times each exception has occurred. In the example shown, the profiler has detected 1,117 occurrences of the same exception within a short window. Timestamps of the first and most recent occurrences are listed to help correlate exception spikes with specific deployment windows, traffic patterns, or configuration changes. A sample stack trace is also displayed for the last recorded instance, offering detailed context including internal libraries, socket behavior, and OTEL exporter involvement. This snapshot aids observability engineers in pinpointing recurring issues introduced or exacerbated by OSS Agent behavior, allowing for improved reliability, tuning, and preventative diagnostics.

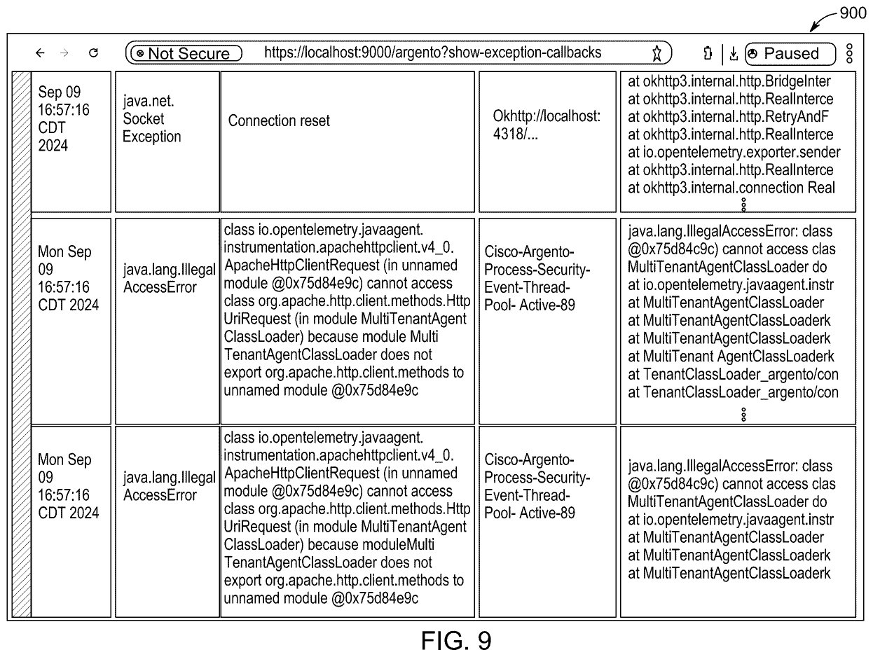

FIG. 9 illustrates an example of Exception Instances 900 caused by the Agent. This is an exception instance (e.g., snapshot) report for Exceptions involving the OSS Agent (as a cause), presenting detailed snapshots of specific exception events generated during OpenTelemetry instrumentation. Each instance includes the timestamp of occurrence, the full exception class name (e.g., java. net. SocketException, java.lang.IllegalAccessError), a textual summary of the error message, and a complete runtime stack trace. Additionally, the affected thread name and contextual metadata (e.g., the classloader or exporting module) are captured to help identify root causes. For example, one captured error shows an illegal access attempt by the agent to a restricted class in a multi-tenant environment, resulting in a java.lang.IllegalAccessError due to module access restrictions. This level of granularity enables administrators to trace exactly where and why agent-induced exceptions occur, aiding in debugging, classloader configuration, and safe OTEL deployment within complex runtime environments.

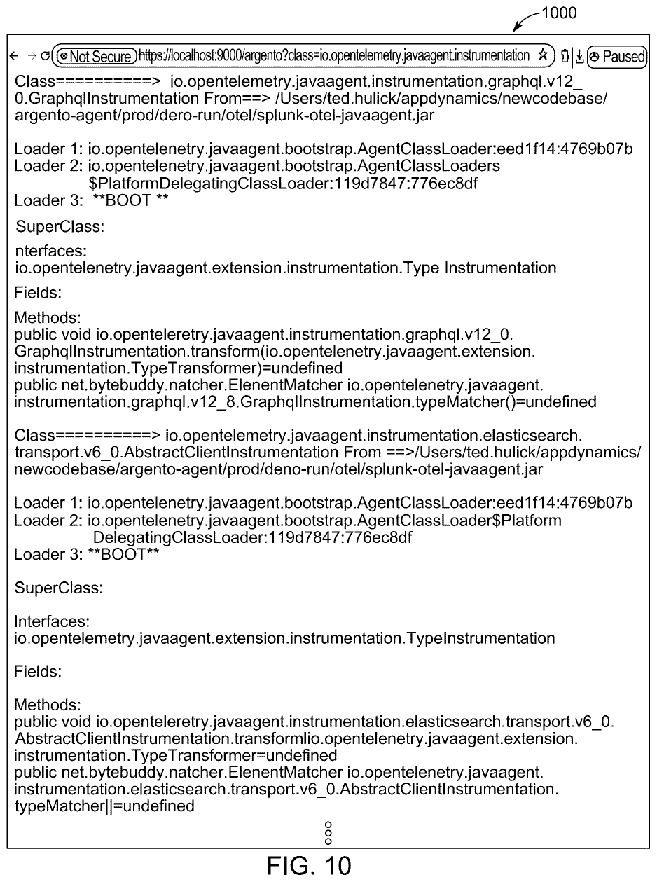

FIG. 10 illustrates an example of OSS Agent Class Exploration 1000, which provides detailed introspection into individual classes loaded and instrumented by the OSS Agent. This exploration view reveals the origin of each class (e.g., the specific JAR file), the associated class loaders, implemented interfaces (such as TypeInstrumentation), and declared methods including OpenTelemetry hook points (e.g., transform( ) and typeMatcher( ) methods). For each class, relevant metadata such as superclass hierarchy, method signatures, and loader depth (e.g., bootstrap, platform) is presented. In the illustrated case, the profiler shows classes from GraphQL and Elasticsearch OpenTelemetry modules, highlighting both their source paths and runtime configuration. This diagnostic view allows observability engineers to validate instrumentation scope, trace potential incompatibilities (e.g., class loader issues), and verify which modules are currently active and their instrumentation entry points.

According to one or more embodiments herein, therefore, the techniques herein are focused on Open Telemetry, and discover pipelines, signals, and components out-of-band without configuration. The techniques herein also measure OTEL impact on the application, including memory, CPU, throughput, etc. Furthermore, the techniques herein specifically intercept Exceptions caused by Open Telemetry implementations.

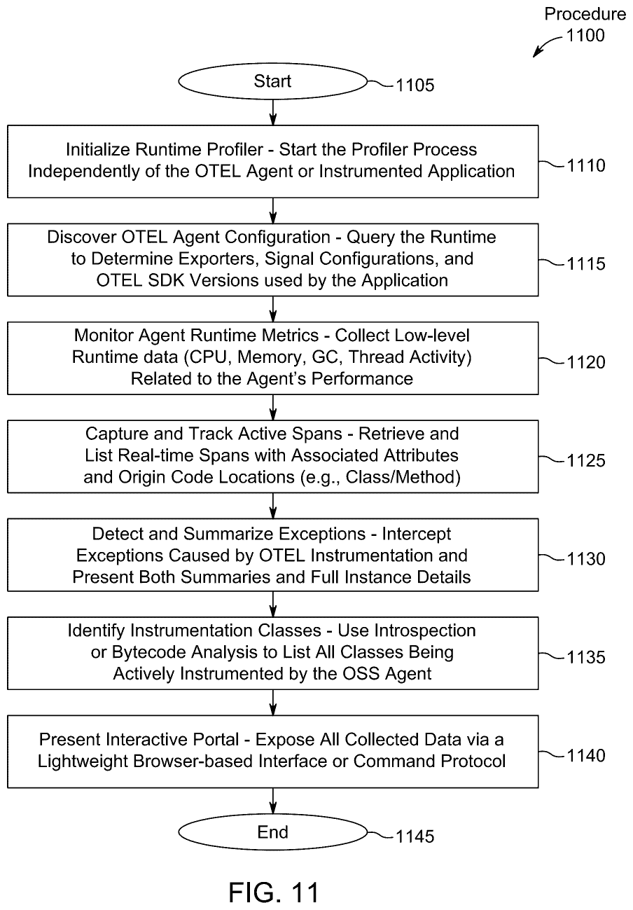

An example of the full system and lifecycle described herein in accordance with one or more embodiments herein can be conceptually summarized in FIG. 11, which presents a high-level process flow (procedure 1100). For example, the procedure 1100 may start at step 1105, and continues to step 1110, where, as described in greater detail above, the OpenTelemetry runtime profiler begins operation independently of the main application or OTEL agent. Upon initialization, in step 1115 it automatically scans (e.g., via a runtime query) and discovers the current OTEL configuration, including which exporters are enabled, what are the signal configurations, and which SDK versions are present and used by the application. Once initialized, in step 1120 the profiler continuously monitors agent-level metrics such as CPU consumption, memory allocation, garbage collection (GC) activity, and thread usage related to the agent's performance.

Simultaneously, in step 1125, the techniques herein track all active and recently closed spans, tagging them with the originating class and method (origin code locations), while capturing any custom attributes. In step 1130, in cases where the OTEL agent causes exceptions, the profiler intercepts these in real time, logs instance details, and compiles summaries to help isolate problems (e.g., presenting both summaries and full instance details). The profiler also identifies and lists instrumentation classes currently being used (and thus actively instrumented) by the OSS Agent in step 1135, such as by using introspection or bytecode analysis. All of this information is then made available through presentation of a lightweight (e.g., browser-based) interface/interactive portal in step 1140, where the exposed collected data allows observability engineers and system admins to interactively explore the agent's inner workings and understand the health and performance of the telemetry system.

Procedure 1100 may end at step 1145, with the notable option to continue monitoring metrics, spans, and so on in real time.

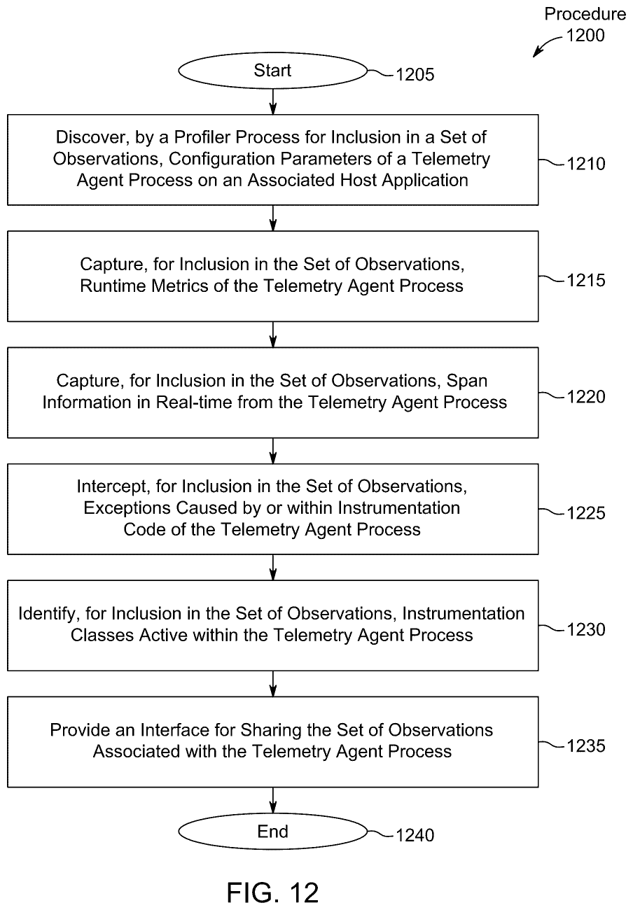

In closing, FIG. 12 illustrates an example simplified procedure for an Open Telemetry runtime profiler in accordance with one or more embodiments described herein. For example, a non-generic, specifically configured device (e.g., device 200, an apparatus) may perform procedure 1200 by executing stored instructions (e.g., process 248). The procedure 1200 may start at step 1205, and continues to step 1210, where, as described in greater detail above, a profiler process discovers, for inclusion in a set of observations, configuration parameters (e.g., exporters, resources, or signal types) of a telemetry agent process on an associated host application.

In step 1215, the profiler process also captures, for inclusion in the set of observations, runtime metrics of the telemetry agent process (e.g., memory usage, CPU utilization, thread activity, or class loading behavior).

In step 1220 the profiler process also captures, for inclusion in the set of observations, span information (e.g., span origins, span attributes, or parent-child relationships) in real-time from the telemetry agent process. Illustratively, each span origin may be traced to a specific class and method using one of either bytecode instrumentation or runtime inspection.

In step 1225 the profiler process also intercepts, for inclusion in the set of observations, exceptions caused by or within instrumentation code of the telemetry agent process. In one embodiment, the profiler process also summarizes, for inclusion in the set of observations, the exceptions caused by or within the instrumentation code of the telemetry agent process (e.g., where the exception summaries may be grouped and categorized by cause, frequency, or impact on the associated host application).

In step 1230 the profiler process also identifies, for inclusion in the set of observations, instrumentation classes active within the telemetry agent process.

Then, in step 1235 the profiler process may provide an interface (e.g., a user interface, such as a lightweight web-based portal independent of the associated host application) for sharing the set of observations associated with the telemetry agent process (e.g., those determined above, optionally plus class structures, instrumentation hooks, execution metrics, etc.). In one embodiment, the techniques herein may also provide, on the interface and on-demand, a snapshot of span activity, instrumentation status, and agent health associated with the telemetry agent process based on a corresponding on-demand set of observations.

Procedure 1200 may end at step 1240, with the notable option to continue capturing, intercepting, identifying, and so on in real time.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In particular, in some implementations, an illustrative method herein may comprise: capturing, by a profiler process for inclusion in a set of observations, runtime metrics of a telemetry agent process on an associated host application; capturing, by the profiler process for inclusion in the set of observations, span information in real-time from the telemetry agent process; intercepting, by the profiler process for inclusion in the set of observations, exceptions caused by or within instrumentation code of the telemetry agent process; and providing, by the profiler process, an interface for sharing the set of observations associated with the telemetry agent process.

In one embodiment, the method further comprises: discovering, by the profiler process for inclusion in the set of observations, configuration parameters of the telemetry agent process. In one embodiment, the configuration parameters comprise one or more of exporters, resources, or signal types of the telemetry agent process.

In one embodiment, the method further comprises: identifying, by the profiler process for inclusion in the set of observations, instrumentation classes active within the telemetry agent process.

In one embodiment, the runtime metrics comprise one or more of memory usage, CPU utilization, thread activity, or class loading behavior of the telemetry agent process.

In one embodiment, the span information comprises one or more of span origins, span attributes, or parent-child relationships. In one embodiment, each span origin is traced to a specific class and method using one of either bytecode instrumentation or runtime inspection.

In one embodiment, the set of observations further comprises one or more of class structures, instrumentation hooks, or execution metrics associated with the telemetry agent process.

In one embodiment, the interface comprises a user interface.

In one embodiment, the interface comprises a lightweight web-based portal independent of the associated host application.

In one embodiment, the method further comprises: summarizing, by the profiler process for inclusion in the set of observations, the exceptions caused by or within the instrumentation code of the telemetry agent process. In one embodiment, exception summaries are grouped and categorized by one or more of cause, frequency, or impact on the associated host application.

In one embodiment, the profiler process operates out-of-band from a primary application instrumentation path.

In one embodiment, the telemetry agent process comprises an Open Telemetry agent and wherein the associated host application comprises a Java application.

In one embodiment, the method further comprises: providing, on the interface and on-demand, a snapshot of span activity, instrumentation status, and agent health associated with the telemetry agent process based on a corresponding on-demand set of observations.

In some implementations, an illustrative apparatus herein may comprise: one or more network interfaces to communicate with a network; a processor coupled to the one or more network interfaces and configured to execute one or more processes; and a memory configured to store a profiler process that is executable by the processor, the profiler process comprising: capturing, for inclusion in a set of observations, runtime metrics of a telemetry agent process on an associated host application; capturing, for inclusion in the set of observations, span information in real-time from the telemetry agent process; intercepting, for inclusion in the set of observations, exceptions caused by or within instrumentation code of the telemetry agent process; and providing an interface for sharing the set of observations associated with the telemetry agent process.

In still other implementations, a tangible, non-transitory, computer-readable medium storing program instructions that cause a device to execute a process (e.g., a profiler process) comprising: capturing, for inclusion in a set of observations, runtime metrics of a telemetry agent process on an associated host application; capturing, for inclusion in the set of observations, span information in real-time from the telemetry agent process; intercepting, for inclusion in the set of observations, exceptions caused by or within instrumentation code of the telemetry agent process; and providing an interface for sharing the set of observations associated with the telemetry agent process.

The techniques described herein, therefore, provide for an Open Telemetry runtime profiler. Open Telemetry (OTEL) is fairly new technology, and there are currently no available profiling systems that are targeted specifically for Open Telemetry. While it is possible to use a standard profiler, such a standard profiler would have no knowledge of what to focus on or what to look for, and it would merely provide generic runtime metrics/etc., and nothing specific to OTEL.

Illustratively, the techniques described herein may be performed by hardware, software, and/or firmware, (e.g., an “apparatus”) such as in accordance with the OTEL runtime profiler process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

For instance, while certain aspects of the present disclosure are described in terms of being performed “by a server” or “by a controller” or “by a collection engine”, those skilled in the art will appreciate that agents of the observability intelligence platform (e.g., application agents, network agents, language agents, etc.) may be considered to be extensions of the server (or controller/engine) operation, and as such, any process step performed “by a server” need not be limited to local processing on a specific server device, unless otherwise specifically noted as such. Furthermore, while certain aspects are described as being performed “by an agent” or by particular types of agents (e.g., application agents, network agents, endpoint agents, enterprise agents, cloud agents, etc.), the techniques may be generally applied to any suitable software/hardware configuration (libraries, modules, etc.) as part of an apparatus, application, or otherwise.

As used herein, the terms “application” and “applications” generally refer to a computer program or computer programs that are designed to carry out a specific task or tasks other than task(s) relating to the operation of the computer itself. In particular, an “application” can refer to a collection of executable computer code that is provided to, or is integrated into, a software system. As a result, the “application” or “applications” discussed herein can refer to any collection computer code that is executed by, or provided by, the software system.

By way of example, the applications mentioned herein can be host applications that run on various computing systems, such as a physical computer (e.g., a desktop, a laptop, a smartphone, a tablet, a phablet, etc.), a virtual computer (e.g., a thin client, a virtual machine, a Linux container, etc.), a data center (e.g., rack server, supercomputer, etc.), and/or a software defined data center (e.g., bare metal server), etc. Accordingly, the applications described herein can be locally provided host applications, virtually provided host applications, and so on and so forth.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
capturing, by a profiler process for inclusion in a set of observations, runtime metrics of a telemetry agent process on an associated host application;
capturing, by the profiler process for inclusion in the set of observations, span information in real-time from the telemetry agent process;
intercepting, by the profiler process for inclusion in the set of observations, exceptions caused by or within instrumentation code of the telemetry agent process; and
providing, by the profiler process, an interface for sharing the set of observations associated with the telemetry agent process.

2. The method as in claim 1, further comprising:
discovering, by the profiler process for inclusion in the set of observations, configuration parameters of the telemetry agent process.

3. The method as in claim 2, wherein the configuration parameters comprise one or more of exporters, resources, or signal types of the telemetry agent process.

4. The method as in claim 1, further comprising:
identifying, by the profiler process for inclusion in the set of observations, instrumentation classes active within the telemetry agent process.

5. The method as in claim 1, wherein the runtime metrics comprise one or more of memory usage, CPU utilization, thread activity, or class loading behavior of the telemetry agent process.

6. The method as in claim 1, wherein the span information comprises one or more of span origins, span attributes, or parent-child relationships.

7. The method as in claim 6, wherein each span origin is traced to a specific class and method using one of either bytecode instrumentation or runtime inspection.

8. The method as in claim 1, wherein the set of observations further comprises one or more of class structures, instrumentation hooks, or execution metrics associated with the telemetry agent process.

9. The method as in claim 1, wherein the interface comprises a user interface.

10. The method as in claim 1, wherein the interface comprises a lightweight web-based portal independent of the associated host application.

11. The method as in claim 1, further comprising:
summarizing, by the profiler process for inclusion in the set of observations, the exceptions caused by or within the instrumentation code of the telemetry agent process.

12. The method as in claim 11, wherein exception summaries are grouped and categorized by one or more of cause, frequency, or impact on the associated host application.

13. The method as in claim 1, wherein the profiler process operates out-of-band from a primary application instrumentation path.

14. The method as in claim 1, wherein the telemetry agent process comprises an Open Telemetry agent and wherein the associated host application comprises a Java application.

15. The method as in claim 1, further comprising:
providing, on the interface and on-demand, a snapshot of span activity, instrumentation status, and agent health associated with the telemetry agent process based on a corresponding on-demand set of observations.

16. A tangible, non-transitory, computer-readable medium storing program instructions that cause a device to execute a profiler process comprising:
capturing, for inclusion in a set of observations, runtime metrics of a telemetry agent process on an associated host application;
capturing, for inclusion in the set of observations, span information in real-time from the telemetry agent process;
intercepting, for inclusion in the set of observations, exceptions caused by or within instrumentation code of the telemetry agent process; and
providing an interface for sharing the set of observations associated with the telemetry agent process.

17. The tangible, non-transitory, computer-readable medium as in claim 16, wherein the profiler process further comprises:
discovering, for inclusion in the set of observations, configuration parameters of the telemetry agent process.

18. The tangible, non-transitory, computer-readable medium as in claim 16, wherein the profiler process further comprises:
identifying, for inclusion in the set of observations, instrumentation classes active within the telemetry agent process.

19. The tangible, non-transitory, computer-readable medium as in claim 16, wherein the interface comprises a user interface.

20. An apparatus, comprising:
one or more network interfaces to communicate with a network;
a processor coupled to the one or more network interfaces and configured to execute one or more processes; and
a memory configured to store a profiler process that is executable by the processor, the profiler process comprising:
capturing, for inclusion in a set of observations, runtime metrics of a telemetry agent process on an associated host application;
capturing, for inclusion in the set of observations, span information in real-time from the telemetry agent process;
intercepting, for inclusion in the set of observations, exceptions caused by or within instrumentation code of the telemetry agent process; and
providing an interface for sharing the set of observations associated with the telemetry agent process.
